(19) United States
(12) Patent Application Publication
(10) Pub. No.: US 2024/0244621 A1
(43) Pub. Date: Jul. 18, 2024

(54) SYSTEMS AND METHODS FOR DETERMINING TIMINGS OF VARIOUS FORWARDING LINKS

(71) Applicant: ZTE Corporation, Shenzhen (CN)

(72) Inventors: Hanqing XU, Shenzhen (CN); Nan ZHANG, Shenzhen (CN); Wei CAO, Shenzhen (CN); Ziyang LI, Shenzhen (CN); Shuang ZHENG, Shenzhen (CN)

(73) Assignee: ZTE Corporation, Shenzhen (CN)

(21) Appl. No.: 18/619,363

(22) Filed: Mar. 28, 2024

Related U.S. Application Data
(63) Continuation of application No. PCT/CN22/88625, filed on Apr. 22, 2022.

(51) Int. Cl. H04W 72/1273; H04W 72/231; H04W 72/51; H04W 76/10

(52) U.S. Cl. CPC H04W 72/1273; H04W 72/231; H04W 72/51; H04W 76/10

(57) ABSTRACT

The present disclosure is directed to determining timings of various forwarding links, including determining, by a network node, based on first timing information associated with a first downlink forwarding link, a timing of a first downlink forwarding link, where the first downlink forwarding link is established between the network node and a wireless communication device.

### CROSS-REFERENCE TO RELATED APPLICATION

This application claims the benefit of priority under 35 U.S.C. § 120 as a continuation of International Patent Application No. PCT/CN2022/088625, Apr. 22, 2022, the disclosure of which is incorporated herein by reference in its entirety.

### TECHNICAL FIELD

The disclosure relates generally to wireless communications and, more particularly, to systems, methods, and non-transitory computer-readable media for determining timings of various forwarding links.

### BACKGROUND

Coverage is a fundamental aspect of cellular network deployments. Mobile operators rely on different types of network nodes to offer blanket coverage in their deployments. Therefore, new types of network nodes have been considered to increase mobile operators' flexibility for their network deployments.

### SUMMARY

The example arrangements relate to determining timings of various forwarding links.

Example arrangements can include a wireless communication method. The method can include determining, by a network node, based on first timing information associated with a first downlink forwarding link, a timing of a first downlink forwarding link, where the first downlink forwarding link is established between the network node and a wireless communication device.

In some arrangements of the wireless communication method, the first timing information indicates a first time difference between the timing of the first downlink forwarding link and a timing of a second downlink forwarding link or a second time difference between the timing of the first downlink forwarding link and a timing of a first downlink communication link, and where the second downlink forwarding link is established between the network node and a wireless communication node, and the first downlink communication link is established between the network node and the wireless communication node.

The wireless communication method can further include receiving, by the network node from a wireless communication node, the first timing information via a signaling including at least one of downlink control information (DCI), medium access control control element (MAC CE) signaling, or radio resource control (RRC) signaling.

The wireless communication method can further include determining, by the network node, based on second timing information associated with a first uplink forwarding link, a timing of a first uplink forwarding link, where the first uplink forwarding link is established between the network node and the wireless communication node.

In some arrangements of the wireless communication method, the second timing information indicates that a timing of the first uplink forwarding link is equal to a timing of a first uplink communication link, where the first uplink communication link is established between the network node and the wireless communication node.

The wireless communication method can further include determining, by the network node, based on third timing information associated with a second uplink forwarding link and at least one of the timing of the first uplink communication link or the timing of the first uplink forwarding link, a timing of a second uplink forwarding link, where the second uplink forwarding link is established between the network node and the wireless communication device.

In some arrangements of the wireless communication method, the third timing information indicates a third time difference between the timing of the second uplink forwarding link and the timing of the first uplink communication link or a fourth time difference between the timing of the second uplink forwarding link and the timing of a first uplink forwarding link.

In some arrangements of the wireless communication method, the second timing information indicates that the timing of the first uplink forwarding link is equal to a timing of a first uplink communication link, the timing of the second downlink forwarding link, or the timing of the first downlink communication link.

The wireless communication method can further include determining, by the network node, based on third timing information associated with a second uplink forwarding link and at least one of the timing of the first uplink communication link, the timing of the first uplink forwarding link, the timing of the second downlink forwarding link, or the timing of the first downlink forwarding link, a timing of a second uplink forwarding link, where the second uplink forwarding link is established between the network node and the wireless communication device.

In some arrangements of the wireless communication method, the third timing information indicates a third time difference between the timing of the second uplink forwarding link and the timing of the first uplink communication link or a fourth time difference between the timing of the second uplink forwarding link and the timing of the first uplink forwarding link.

In some arrangements of the wireless communication method, the first timing information, independent of timing information associated with a communication link, indicates a first time difference between a timing of the first downlink forwarding link and a timing of a second downlink forwarding link, and where the second downlink forwarding link is established between the network node and a wireless communication node.

The wireless communication method can further include determining, by the network node, based on second timing information associated with a first uplink forwarding link, a timing of the first uplink forwarding link, where the first uplink forwarding link is established between the network node and the wireless communication node.

In some arrangements of the wireless communication method, the second timing information, independent of timing information associated with a communication link, indicates that the timing of the first uplink forwarding link is equal to the timing of the second downlink forwarding link.

The wireless communication method can further include determining, by the network node, based on third timing information associated with a second uplink forwarding link and at least one of the timing of the timing of the first uplink forwarding link, the timing of the second downlink forwarding link, or the timing of the first downlink forwarding link, a timing of the second uplink forwarding link, where the second uplink forwarding link is established between the network node and the wireless communication device.

In some arrangements of the wireless communication method, the third timing information, independent of timing information associated with a communication link, indicates a third time difference between the timing of the second uplink forwarding link and the timing of the first uplink forwarding link.

The wireless communication method can further include sending, by the network node to a wireless communication node, one or more capability parameters each indicating at least one switching delay that the network node can support.

The wireless communication method can further include sending, by the network node to a wireless communication node, a plurality of capability parameters, each of the plurality of capability parameters corresponding to a time delay of a switching scenario.

The wireless communication method can further include receiving, by the network node from a wireless communication node, a number of guard symbols or a reserved time blank duration corresponding one of a plurality of switching scenarios.

In some arrangements of the wireless communication method, the number of guard symbols or the reserved time blank duration is more than or equal to a switching delay that the network node can support.

A wireless communication method can include sending, by a wireless communication node to a network node, first timing information associated with a first downlink forwarding link, where the first downlink forwarding link is established between the network node and a wireless communication device.

In some arrangements of the wireless communication method, the first timing information indicates a first time difference between a timing of the first downlink forwarding link and a timing of a second downlink forwarding link or a second time difference between the timing of the first downlink forwarding link and a timing of a first downlink communication link, and where the second downlink forwarding link is established between the network node and a wireless communication node, and the first downlink communication link is established between the network node and the wireless communication node.

The wireless communication method can further include sending, by the wireless communication node to the network node, second timing information associated with a first uplink forwarding link, where the first uplink forwarding link is established between the network node and the wireless communication node.

In some arrangements of the wireless communication method, the second timing information indicates that the timing of the first uplink forwarding link is equal to a timing of a first uplink communication link, the timing of the second downlink forwarding link, or the timing of the first downlink communication link.

The wireless communication method can further include sending, by the wireless communication node to the network node, third timing information associated with a second uplink forwarding link, where the second uplink forwarding link is established between the network node and the wireless communication device.

In some arrangements of the wireless communication method, the third timing information, independent of timing information associated with a communication link, indicates a third time difference between the timing of the second uplink forwarding link and the timing of the first uplink forwarding link.

A wireless communications apparatus can include a processor and a memory, where the processor is configured to read code from the memory and implement a method according to present implementations.

A computer program product can include a computer-readable program medium code stored thereupon, the code, that when executed by a processor, can cause the processor to implement a method according to present implementations.

The above and other aspects and their arrangements are described in greater detail in the drawings, the descriptions, and the claims.

### BRIEF DESCRIPTION OF THE DRAWINGS

Various example arrangements of the present solution are described in detail below with reference to the following figures or drawings. The drawings are provided for purposes of illustration only and merely depict example arrangements of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example wireless communication network, and/or system, in which techniques disclosed herein may be implemented, in accordance with some arrangements.

FIG. 2 illustrates a block diagram of an example wireless communication system for transmitting and receiving wireless communication signals in accordance with some arrangements.

FIG. 3 is a diagram illustrating a configuration of a BS, SN and UE, according to various arrangements.

FIG. 4 is a diagram illustrating a first transmission configuration, according to various arrangements.

FIG. 5 is a diagram illustrating a second transmission configuration, according to various arrangements.

FIG. 6 is a diagram illustrating a third transmission configuration, according to various arrangements.

FIG. 7 is a diagram illustrating a fourth transmission configuration, according to various arrangements.

FIG. 8 is a diagram illustrating a fifth transmission configuration, according to various arrangements.

FIG. 9 is a table illustrating switching scenarios, according to various arrangements.

FIG. 10 is a diagram illustrating an example method for determining timings of various forwarding links, according to various arrangements.

### DETAILED DESCRIPTION

Various example arrangements of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example arrangements and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

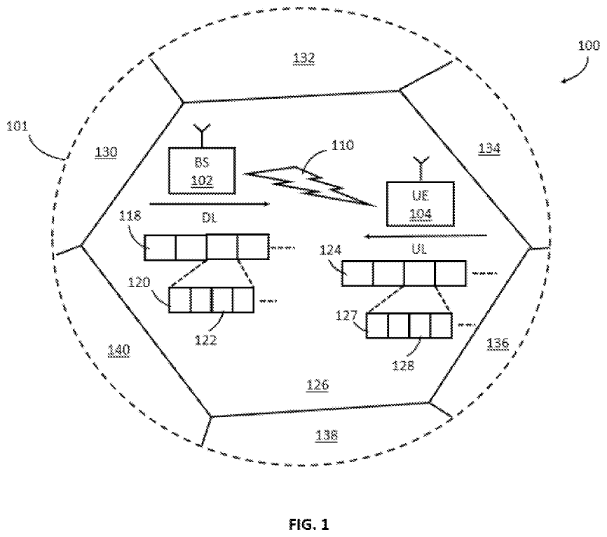

FIG. 1 illustrates an example wireless communication network, and/or system, 100 in which techniques disclosed herein may be implemented, in accordance with an arrangement of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (also referred to as wireless communication node) and a UE device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the base station 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the base station 102 may operate at an allocated channel transmission bandwidth to provide adequate coverage to the UE 104. The base station 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the base station 102 and UE 104 are described herein as non-limiting examples of “communication nodes,” generally, which can practice the methods disclosed herein. Such communication nodes may be capable of wireless and/or wired communications, in accordance with various arrangements of the present solution.

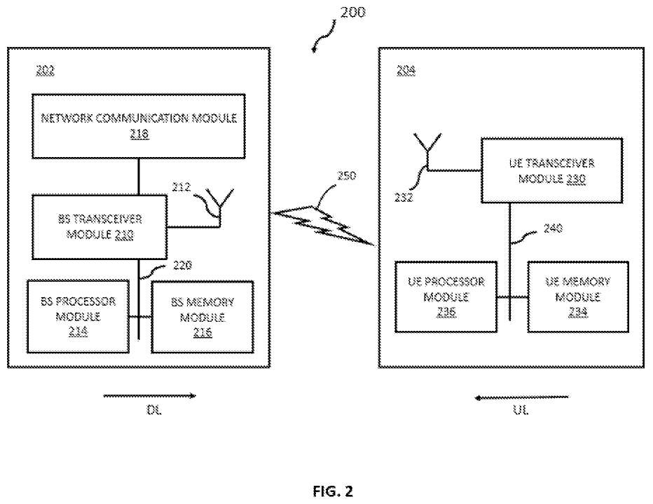

FIG. 2 illustrates a block diagram of an example wireless communication system 200 for transmitting and receiving wireless communication signals (e.g., OFDM/OFDMA signals) in accordance with some arrangements of the present disclosure. The system 200 may include components and elements configured to support known or conventional operating features that need not be described in detail herein. In one illustrative arrangement, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the arrangements disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure

In accordance with some arrangements, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some arrangements, the BS transceiver 210 may be referred to herein as a “downlink” transceiver 210 that includes a RF transmitter and a RF receiver each comprising circuity that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some arrangements, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative arrangements, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various arrangements, the BS 202 may be an evolved node B (eNB), gNB, a serving eNB, a target eNB, a femto station, or a pico station, for example. In some arrangements, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the arrangements disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some arrangements, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

For example, Integrated Access and Backhaul (IAB) in Rel-16 and in Rel-17 is a type of network node not requiring a wired backhaul. Present implementations can include various cases of transmission timing alignment across IAB-nodes and IAB-donors. A first case can include DL transmission timing alignment across IAB-nodes and IAB-donors. If DL TX and UL RX are not well aligned at the parent node, additional information about the alignment is needed for the child node to properly set its DL TX timing for OTA based timing & synchronization. A second case can include DL and UL transmission timing is aligned within an IAB-node. A third case can include DL and UL reception timing is aligned within an IAB-node. A fourth case be within an IAB-node, when transmitting using the second case while when receiving using the third case. A fifth case can include the first case for access link timing and the fourth case for backhaul link timing within an IAB-node in different time slots.

A sixth case can include DL transmission timing of the first case and UL transmission timing of the second case. As one example, the DL transmission timing for all IAB-nodes is aligned with the parent IAB-node or donor DL timing. The UL transmission timing of an IAB-node can be aligned with the IAB-node's DL transmission timing. A seventh case can include DL transmission timing of the first case and UL reception timing of the third case. DL transmission timing for all IAB-nodes is aligned with the parent IAB-node or donor DL timing. UL reception timing of an IAB-node can be aligned with the IAB-node's DL reception timing. If DL TX and UL RX are not well aligned at the parent node, additional information about the alignment is needed for the child node to properly set its DL TX timing for OTA based timing & synchronization.

Another type of network node is the RF repeater which can amplify-and-forward any signal that it receive. RF repeaters are compatible with deployments in 2G, 3G and 4G to supplement the coverage provided by regular full-stack cells. RF repeater only has radio unit.

In Rel-18, a network-controlled repeater is introduced as an enhancement with the capability to receive and process side control information from the network. Side control information can allow a network-controlled repeater to perform its amplify-and-forward operation in a more efficient manner. Advantages include mitigation of unnecessary noise amplification, transmissions and receptions with better spatial directivity, and simplified network integration. The network-controlled repeater can be regarded as a stepping stone of Re-configurable intelligent surface (RIS), a RIS node can adjust the phase and amplitude of received signal to improve the coverage.

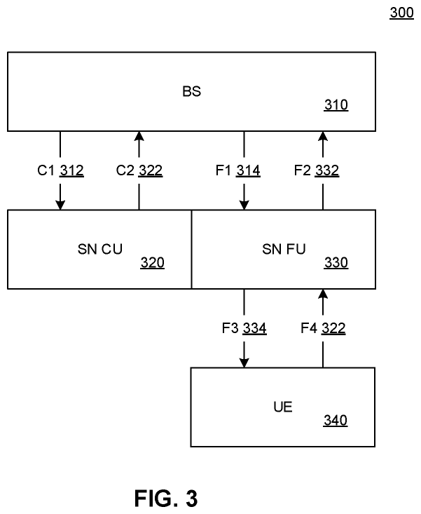

FIG. 3 is a diagram illustrating a configuration of a BS, SN and UE, according to various arrangements. As illustrated by way of example in FIG. 3, an example configuration 300 can include BS 310, SN CU 320, SN FU 330, and UE 340. The BS 310 can transmit C1 312 to SN CU 320 and F1 314 to SN FU 330. The SN CU 320 can transmit C2 322 to BS 310. The SN FU 330 can transmit F2 332 to BS 310 and F3 334 to UE 340. The UE 340 can transmit F4 322 to SN FU 330.

The SN can include two units to support different functions: a first unit and a second unit respectively. Among them, the first unit acts like a UE to receive and decode side control information from the BS, as a communication/control unit (CU), mobile terminal (MT), part of UE, third-party IoT device and the like. The second unit carries out intelligent amplify-and-forward operation using the side control information received by the first unit of the SN. So it can also be called forwarding unit (FU), radio unit(RU), RIS and so on. In the following parts of the disclosure, for convenience of description, CU and FU are used to refer to the first unit and the second unit of the SN respectively.

As illustrated by way of example in FIG. 3, transmission links between BS to SN and SN to UE can include one or more of a communication link (or called control link) from BS to SN CU (C1), a communication link from SN CU to BS (C2), a forwarding link from BS to SN FU (F1), a forwarding link from SN FU to BS (F2), a forwarding link from SN FU to UE (F3), and a forwarding link from UE to SN FU (F4). A communication link can indicate a signal from one side will be detected and decoded by the other side, so that the information transmitting in communication link can be utilized to control the status of forwarding links. A forwarding link can indicate that a signal from BS or UE is unknown by SN FU. Here, SN FU can amplify and forward signals without decoding them. F1 and F3 include the complete DL forwarding link from BS to UE, in which F3 includes the SN FU DL forwarding link, F2 are F4 include the complete UL forwarding link from UE to BS, and in which F2 includes the SN FU UL forwarding link.

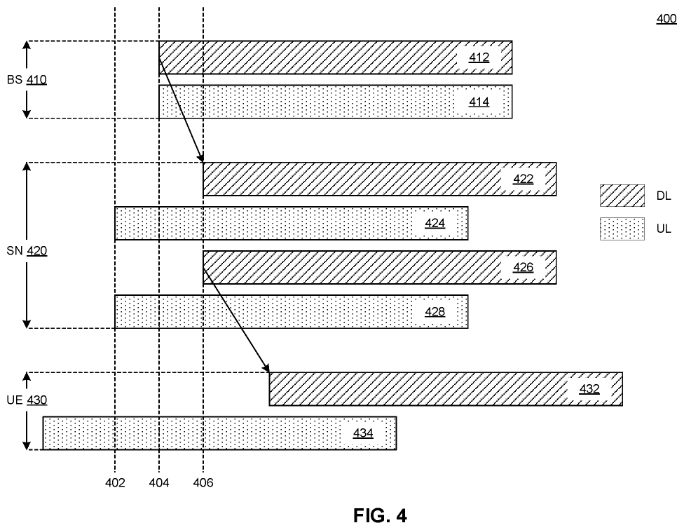

FIG. 4 is a diagram illustrating a first transmission configuration, according to various arrangements. As illustrated by way of example in FIG. 4, an example configuration 400 can include a downlink transmission 412 and an uplink transmission 414 of BS 410, first and second downlink transmissions 422 and 426 and first and second uplink transmissions 424 and 428 of SN 420, and a downlink transmission 432 and an uplink transmission 434 of UE 430. The configuration can be associated with transmission times 402, 404, and 406.

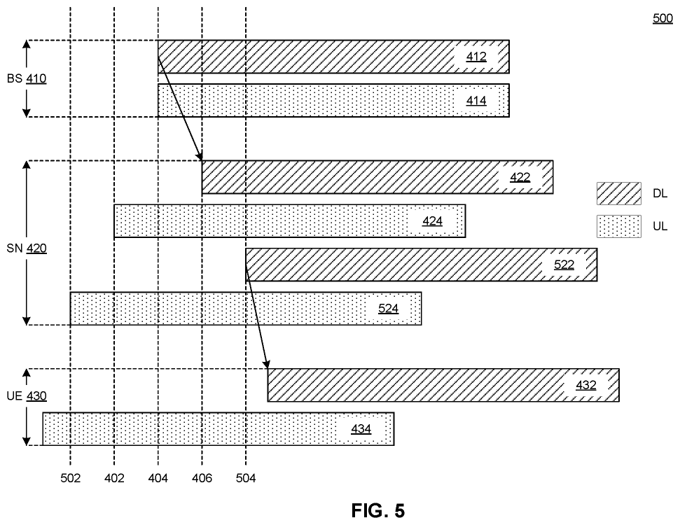

As one example, the SN sets SN CU transmission (C2) time or timing as for a “UE” in clause 4.2 in 3GPP TS 38.213. In this embodiment, the timing of communication link and forwarding link between the BS and the SN is the same (as shown in FIGS. 4 and 5 by way of example), including at least one of various characteristics. A characteristic can include timing of SN FU DL reception (F1) that is the same as the timing of SN CU reception (C1). A characteristic can include timing of SN FU UL transmission (F2) that is the same as the timing of SN CU transmission (C2). A characteristic can include an SN that can set its transmission (TX) time and reception (RX) time according to the following one or more determination rules of timing alignment.

A first determination can include determining the timing of SN FU DL transmission (F3). As one example, the timing of SN FU DL transmission (F3) is the same as the timing of SN FU DL reception (F1) or the timing of SN CU reception (C1), as shown in FIG. 4. As another example, the SN (or SN CU) can know or assume there is a time difference between SN FU DL transmission (F3) and SN FU DL reception (F1), or between SN FU DL transmission (F3) and SN CU reception (C1), as shown in FIG. 5. The time difference can be indicated to the SN by a DCI, a MAC CE or a RRC signaling sent by the BS. The SN uses the time difference and the timing of SN FU DL reception (F1) or the timing of SN CU reception (C1) to determine SN FU DL transmission (F3) time. For example, the SN delays T us (T=the time difference) after receiving DL transmission from the BS and then starts to amplify-and-forward DL transmission. The value of this time difference can be restricted by a value range, e.g. from Tmin to Tmax. Tmin and Tmax can be determined by RAN4.

As another example, the SN can report a capability parameter(s) to the BS, which indicates a switching time delay(s) that the SN can support. The switching time delay can be group delay and/or some other types of time delay. The SN can report multiple capability parameters corresponding to the switching time delays of different direction switching groups (e.g. switching from SN FU DL RX to DL TX, or from SN FU UL RX to UL TX). The time difference can be equal to or more than the switching time delay indicated by the capability parameter(s). An SN can perform DL on/off according to above timing of DL RX (C1 and/or F1) and/or DL TX (F3).

A second determination can include determining the timing of SN FU UL transmission (F2) and/or SN FU UL reception (F4). The SN can set SN FU UL transmission/reception time or perform SN UL on/off according to the following one or more rules of timing alignment. A first timing alignment rule can define that the SN sets SN FU UL transmission (F2) time as for a “UE” in clause 4.2 in 3GPP TS 38.213, or the SN sets SN FU UL transmission (F2) time the same as SN CU transmission (C2) time, or SN FU UL reception (F4) as shown in FIG. 4. A second timing alignment rule can define that the SN sets SN FU UL reception (F4) time the same as the UL transmission time for a “UE” in clause 4.2 in 3GPP TS 38.213, or the same as SN CU transmission (C2) time or SN FU UL transmission (F2) time, as shown in FIG. 4.

FIG. 5 is a diagram illustrating a second transmission configuration, according to various arrangements. As illustrated by way of example in FIG. 5, an example configuration 500 can include the downlink transmission 412 and the uplink transmission 414 of BS 410, the first downlink transmission 422 and the first uplink transmission 424 of SN 420, the downlink transmission 432 and the uplink transmission 434 of UE 430, and a second downlink transmission 522 and a second uplink transmission 524 of SN 420. The configuration can be associated with the transmission times 402, 404, and 406, and transmission times 502 and 504.

As one example, the SN (or SN CU) can know or assume there is a time difference between SN FU UL reception (F4) and SN FU UL transmission (F2), or between SN FU UL reception (F4) and SN CU transmission (C2), as shown in FIG. 5. The time difference can be indicated to the SN by a DCI, a MAC CE or a RRC signaling sent by the BS. The SN uses the time difference and the timing of C2 or F2 to determine SN FU UL reception (F4) time. As another example, the SN uses the time difference and the timing of F4 to determine SN FU UL transmission (F2) time. The definition and value of the timing difference are the same as those described above for FU DL transmission and will not be repeated here. The SN can perform UL on/off according to above timing of SR UL TX (C2 and/or F2) and/or SR UL RX (F4).

An SN can perform on/off according to above timing of DL RX (C1 and/or F1), DL TX (F3), SR UL TX (C2 and/or F2) and/or SR UL RX (F4).

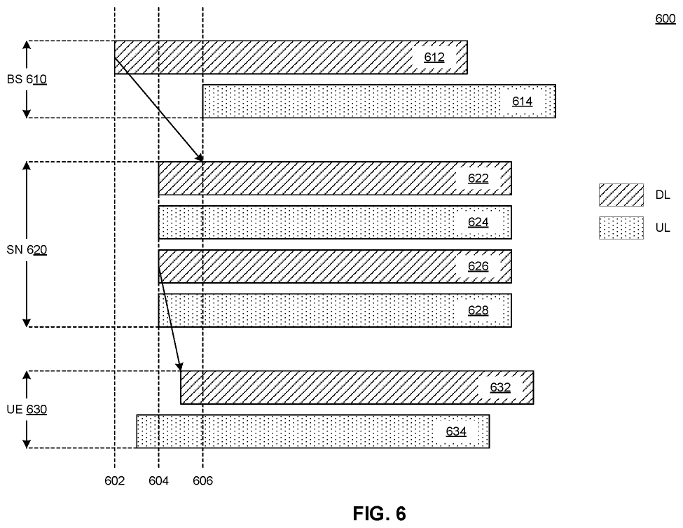

FIG. 6 is a diagram illustrating a third transmission configuration, according to various arrangements. As illustrated by way of example in FIG. 6, an example configuration 600 can include a downlink transmission 612 and an uplink transmission 614 of BS 610, first and second downlink transmissions 622 and 626 and first and second uplink transmissions 624 and 628 of SN 620, and a downlink transmission 632 and an uplink transmission 634 of UE 630. The configuration 600 can be associated with transmission times 602, 604, and 606.

As one example, the SN sets SN CU transmission (C2) time (or timing, the same below) the same as SN CU reception (C1), SN FU DL reception (F1), or SN FU DL transmission (F3). Here, the timing of communication link and forwarding link between the BS and the SN is the same, including at least one of the following timings. A timing of SN CU reception (C1) can be the same as the timing of SN FU DL reception (F1). A timing of SN CU transmission (C2) can be the same as the timing of SN FU UL transmission (F2).

As one example, the SN can set its transmission (TX) time and reception (RX) time according to the following one or more determination rules of timing alignment. A first determination can include determining the timing of SN FU DL transmission (F3). As one example, the timing of SN FU DL transmission (F3) is the same as the timing of SN FU DL reception (F1) or the timing of SN CU reception (C1), as shown in FIG. 4. As another example, the SN (or SN CU) can know or assume there is a time difference between SN FU DL transmission (F3) and SN FU DL reception (F1), or between SN FU DL transmission (F3) and SN CU reception (C1), similar to FIG. 3. The time difference can be indicated to the SN by a DCI, a MAC CE or a RRC signaling sent by the BS. The SN uses the time difference and the timing of F1 or C1 to determine SN FU DL transmission (F3) time. For example, the SN delays T us (T=the time difference) after receiving DL transmission from the BS and then starts to amplify-and-forward DL transmission. The value of this time difference can be restricted by a value range, e.g. from Tmin to Tmax. Tmin and Tmax can be determined by RAN4.

As another example, the SN can report a capability parameter(s) to the BS, which indicates a switching time delay(s) that the SN can support. The switching time delay can be group delay and/or some other types of time delay. The SN can report multiple capability parameters corresponding to the switching time delays of different direction switching groups (e.g. switching from SN FU DL RX to DL TX, or from SN FU UL RX to UL TX). The time difference can be equal to or more than the switching time delay indicated by the capability parameter(s). The SN can perform DL on/off according to above timing of DL RX (C1 and/or F1) and/or DL TX (F3).

A second determination can include determining the timing of SN FU UL transmission (F2) and/or SN FU UL reception (F4). The SN can set SN FU UL transmission/reception time or perform SN UL on/off according to the following one or more rules of timing alignment. The timing alignment can indicate that SN sets SN FU UL transmission (F2) time the same as SN CU transmission (C2) time, SN CU reception (C1) time, or SN FU DL reception (F1) time, as shown in FIG. 6. The timing alignment can indicate that the SN sets SN FU UL reception (F4) time the same as SN CU transmission (C2) time, SN FU UL transmission (F2) time, SN FU DL reception (F1) time, or SN FU DL transmission (F3) time, as shown in FIG. 6. As another example, the SN (or SN CU) can know or assume there is a time difference between SN FU UL reception (F4) and SN FU UL transmission (F2), or between SN FU UL reception (F4) and SN CU transmission (C2). The time difference can be indicated to the SN by a DCI, a MAC CE or a RRC signaling sent by the BS. The SN uses the time difference and the timing of C2, F2, F1 or F3 to determine SN FU UL reception (F4) time. The definition and value of the timing difference can be the same as those described above for FU DL transmission and will not be repeated here. The SN can perform UL on/off according to above timing of SR UL TX (C2 and/or F2) and/or SR UL RX (F4).

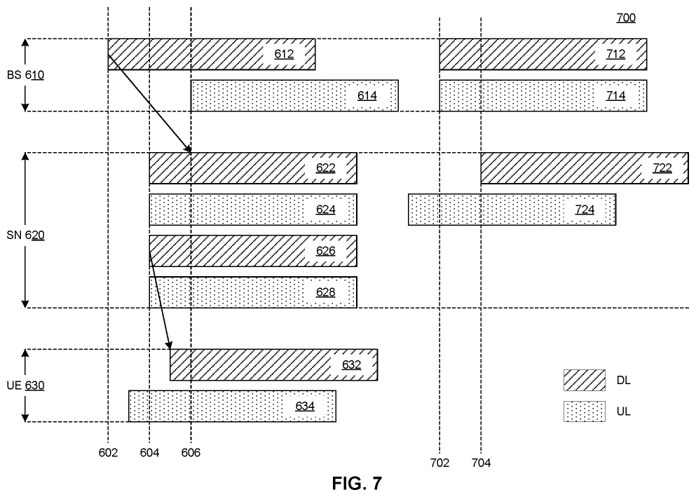

FIG. 7 is a diagram illustrating a fourth transmission configuration, according to various arrangements. As illustrated by way of example in FIG. 7, an example configuration 700 can include the downlink transmission 612 and the uplink transmission 614 of BS 610, the first and second downlink transmissions 622 and 626 the first and second uplink transmissions 624 and 628 of SN 620, the downlink transmission 632 and the uplink transmission 634 of UE 630. The configuration 700 can be associated with the transmission times 602, 604, and 606. The configuration 700 can also include a downlink transmission 712 and an uplink transmission 714 of BS 610, and a third downlink transmission 722 and a third uplink transmission 724 of BS 620. The configuration 700 can be associated with the transmission times 702 and 704.

In this embodiment, the timing of communication link and forwarding link between the BS and the SN can be different, including at least one of various characteristics. A characteristic can indicate that the SN sets CU transmission (C2) time (or timing) as for a “UE” in clause 4.2 in TS 38.213. A characteristic can indicate that the timing of CU transmission (C2) is different from the timing of SN FU UL transmission (F2). The SN can set its transmission (TX) time and reception (RX) time according to the following one or more determination rules of timing alignment.

A first determination can include determining the timing of SN FU DL transmission (F3). Here, the timing of SN FU DL transmission (F3) is the same as the timing of SN FU DL reception (F1), as shown in FIG. 7. As another example, the SN (or SN CU) can know or assume there is a time difference between SN FU DL transmission (F3) and SN FU DL reception (F1), similar to FIG. 3. The time difference can be indicated to the SN by a DCI, a MAC CE or a RRC signaling sent by the BS. The SN uses the time difference to determine SN FU DL transmission (F3) time. For example, the SN delays T us (T=the time difference) after receiving DL transmission from the BS and then starts to amplify-and-forward DL transmission. The value of this time difference can be restricted by a value range, e.g. from Tmin to Tmax. Tmin and Tmax can be determined by RAN4.

As another example, the SN can report a capability parameter(s) to the BS, which indicates a switching time delay(s) that the SN can support. The switching time delay can be group delay and/or some other types of time delay. The SN can report multiple capability parameters corresponding to the switching time delays of different direction switching groups (e.g. switching from SN FU DL RX to DL TX, or from SN FU UL RX to UL TX). The time difference should be equal to or more than the switching time delay indicated by the capability parameter(s). The SN can perform DL on/off according to above timing of DL RX (C1 and/or F1) and/or DL TX (F3).

A second determination can include determining the timing of SN FU UL transmission (F2) and/or SN FU UL reception (F4). The SN can set SN FU UL transmission/reception time or perform SN UL on/off according to the following one or more rules of timing alignment. A first timing alignment rule can define that the SN sets SN FU UL transmission (F2) time the same as SN FU DL reception (F1) time, as shown in FIG. 7. A first timing alignment rule can define that the SN sets SN FU UL reception (F4) time the same as SN FU UL transmission (F2) time, SN FU DL reception (F1) time, or SN FU DL transmission (F3) time, as shown in FIG. 7. As another example, the SN (or SN CU) can know or assume there is a time difference between SN FU UL reception (F4) and SN FU UL transmission (F2). The time difference can be indicated to the SN by a DCI, a MAC CE or a RRC signaling sent by the BS. The SN uses the time difference to determine SN FU UL reception (F4) time. The definition and value of the timing difference are the same as those described above for FU DL transmission and will not be repeated here. The SN perform UL on/off according to above timing of SR UL TX (C2 and/or F2) and/or SR UL RX (F4).

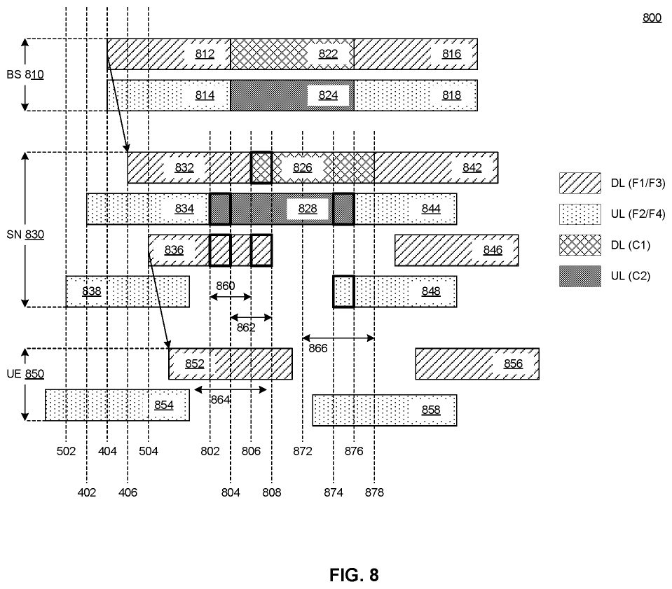

FIG. 8 is a diagram illustrating a fifth transmission configuration, according to various arrangements. As illustrated by way of example in FIG. 8, an example configuration 800 can include transmissions associated with BS 810, transmissions associated with SN 830, and transmissions associated with UE 850. The transmissions associated with BS 810 can include first and second F1 downlink transmissions 812 and 816, first and second F2 uplink transmissions 814 and 818, a C1 downlink transmission 822, and a C2 uplink transmission 824. The transmissions associated with SN 830 can include first and second F1 downlink transmissions 832 and 842, first and second F2 uplink transmissions 834 and 844, first and second F3 downlink transmissions 836 and 846, first and second F4 uplink transmissions 838 and 848, a C1 downlink transmission 826, and a C2 uplink transmission 828. The transmissions associated with UE 850 can include first and second F3 downlink transmissions 852 and 856, and first and second F4 uplink transmissions 854 and 858. The configuration can be associated with the transmission times 402, 404, 406, 502 and 504, and transmission times 802, 804, 806, 808, 872, 874, 876 and 878. The transmissions can be associated with GP1 860, GP1 862, GP2 864 and GP2 866. The transmissions can also include one or more collisions, illustrated by way of example as rectangular outlines in various transmissions of configuration 800. Timing misalignment between SR control links and SR forwarding links may lead to resource collision. Based on the timing scheme as shown in FIG. 5, FIG. 8 illustrates an example operation corresponding to resource collision between SR CU links and SR FU links.

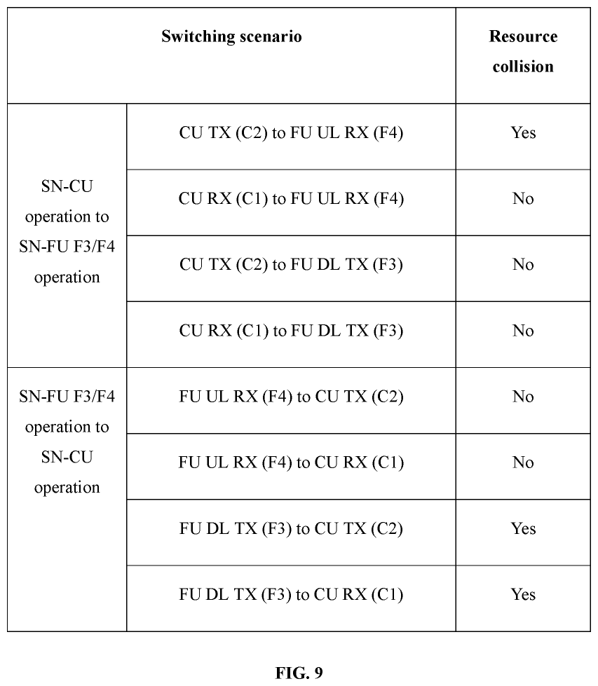

FIG. 9 is a table illustrating switching scenarios, according to various arrangements. In order to solve resource collision, the following one or more schemes can be used.

In a first example scheme, the SN (SN CU) can report one or more capability parameter(s) to the BS, which indicate(s) switching time delay(s) that the SN can support. The switching time delay can include a group delay and/or some other types of time delay. The SN can report multiple capability parameters corresponding to the switching time delays of different direction switching groups (e.g. switching from SN FU DL RX to DL TX, from SN FU UL RX to UL TX, from SN FU UL RX to DL TX, or from SN FU DL Rx to UL TX, etc.).

In a second example scheme, the BS (or OAM) indicates the number of guard symbols or reserved time blank duration to the SN (SN CU). The indicated number of guard symbols or reserved time blank duration can correspond to each of multiple switching scenarios. The multiple switching scenarios can include one or more of the eight switching scenarios in FIG. 9. Other switching scenarios is not precluded: e.g. switching between CU RX (C1) and FU DL RX (F1), CU RX (C1) and FU UL TX (F2), CU TX (C2) and FU DL RX (F1), CU TX (C2) and FU UL TX (F2). The number of guard symbols or reserved time blank duration should be equal to or larger than the switching time delay that the SN support.

For example, for the timing scheme as shown in FIG. 5, the BS can indicate the number of guard symbols or reserved time blank duration for the following one or more switching scenarios. A switching scenario can include a CU TX (C2) to FU UL RX (F4). A switching scenario can include an FU DL TX (F3) to CU TX (C2). A switching scenario can include an FU DL TX (F3) to CU RX (C1). The number and/or the location of guard symbols or reserved blank time duration can be indicated to the SN via a DCI, a MAC CE or a RRC signaling. As one example, the BS can configure the guard symbols as “Not Available” in the slot format.

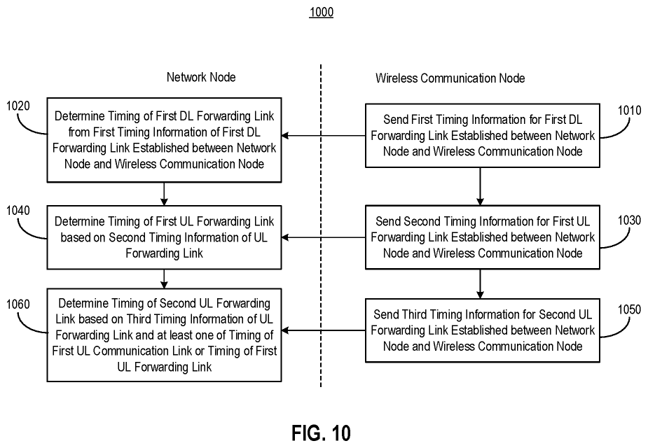

FIG. 10 is a diagram illustrating an example method 1000 for determining timings of various forwarding links, according to various arrangements. Referring to FIGS. 1-9, the method 1000 can be performed by the UE 104 and the BS 102.

At 1010, the method can send first timing information for a first DL forwarding link. As one example, the UE 104 can send the first timing information to the BS 102. As another example, the first DL forwarding link can be established between a network Node and a wireless communication node. The method 1000 can then continue to 1020 and 1030.

At 1020, the method can determine timing of a first DL forwarding link from a first timing information of the first DL forwarding link. As one example, the BS 102 can determine the timing of the first DL forwarding link. As another example, the first DL forwarding link can be established between a network Node and a wireless communication node. The method 1000 can then continue to 1040.

At 1030, the method can send second timing Information for a first UL forwarding link. As one example, the UE 104 can send the first timing information to the BS 102. As another example, the first UL forwarding link can be established between a network node and a wireless communication node. The method 1000 can then continue to 1040 and 1050.

At 1040, the method can determine timing of a first UL forwarding link based on second timing information of a UL forwarding link. As one example, the BS 102 can determine the timing of the first UL forwarding link. The method 1000 can then continue to 1060.

At 1050, the method can send third timing information for a second UL forwarding link. As one example, the UE 104 can send the third timing information. As another example, the second UL forwarding link can be established between a network node and a wireless communication node. The method 1000 can then continue to 1060.

At 1060, the method can determine timing of a second UL forwarding link based on third timing information of the second UL forwarding link and at least one of a timing of a first UL communication link or a timing of a first UL forwarding link. As one example, the BS 102 can determine the timing of the second UL forwarding link. The method 1000 can end at 1060.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program (e.g., a computer program product) or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according arrangements of the present solution.

Additionally, memory or other storage, as well as communication components, may be employed in arrangements of the present solution. It will be appreciated that, for clarity purposes, the above description has described arrangements of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the arrangements described in this disclosure will be readily apparent to those skilled in the art, and the general principles defined herein can be applied to other arrangements without departing from the scope of this disclosure. Thus, the disclosure is not intended to be limited to the arrangements shown herein, but is to be accorded the widest scope consistent with the novel features and principles disclosed herein, as recited in the claims below.

What is claimed is:

1. A wireless communication method, comprising:
determining, by a network node, based on first timing information associated with a first downlink forwarding link, a timing of a first downlink forwarding link,
wherein the first downlink forwarding link is established between the network node and a wireless communication device.

2. The wireless communication method of claim 1, wherein the first timing information indicates a first time difference between the timing of the first downlink forwarding link and a timing of a second downlink forwarding link or a second time difference between the timing of the first downlink forwarding link and a timing of a first downlink communication link, and wherein the second downlink forwarding link is established between the network node and a wireless communication node, and the first downlink communication link is established between the network node and the wireless communication node.

3. The wireless communication method of claim 1, further comprising receiving, by the network node from a wireless communication node, the first timing information via a signaling comprising at least one of: downlink control information (DCI), medium access control control element (MAC CE) signaling, or radio resource control (RRC) signalling.

4. The wireless communication method of claim 2, further comprising:
determining, by the network node, based on second timing information associated with a first uplink forwarding link, a timing of a first uplink forwarding link,
wherein the first uplink forwarding link is established between the network node and the wireless communication node.

5. The wireless communication method of claim 4, wherein the second timing information indicates that a timing of the first uplink forwarding link is equal to a timing of a first uplink communication link, wherein the first uplink communication link is established between the network node and the wireless communication node.

6. The wireless communication method of claim 5, further comprising:
determining, by the network node, based on third timing information associated with a second uplink forwarding link and at least one of the timing of the first uplink communication link or the timing of the first uplink forwarding link, a timing of a second uplink forwarding link,
wherein the second uplink forwarding link is established between the network node and the wireless communication device.

7. The wireless communication method of claim 6, wherein the third timing information indicates a third time difference between the timing of the second uplink forwarding link and the timing of the first uplink communication link or a fourth time difference between the timing of the second uplink forwarding link and the timing of a first uplink forwarding link.

8. The wireless communication method of claim 4, wherein the second timing information indicates that the timing of the first uplink forwarding link is equal to a timing of a first uplink communication link, the timing of the second downlink forwarding link, or the timing of the first downlink communication link.

9. The wireless communication method of claim 8, further comprising:
determining, by the network node, based on third timing information associated with a second uplink forwarding link and at least one of the timing of the first uplink communication link, the timing of the first uplink forwarding link, the timing of the second downlink forwarding link, or the timing of the first downlink forwarding link, a timing of a second uplink forwarding link,
wherein the second uplink forwarding link is established between the network node and the wireless communication device.

10. The wireless communication method of claim 9, wherein the third timing information indicates a third time difference between the timing of the second uplink forwarding link and the timing of the first uplink communication link or a fourth time difference between the timing of the second uplink forwarding link and the timing of the first uplink forwarding link.

11. The wireless communication method of claim 1, wherein the first timing information, independent of timing information associated with a communication link, indicates a first time difference between a timing of the first downlink forwarding link and a timing of a second downlink forwarding link, and wherein the second downlink forwarding link is established between the network node and a wireless communication node.

12. The wireless communication method of claim 11, further comprising:
determining, by the network node, based on second timing information associated with a first uplink forwarding link, a timing of the first uplink forwarding link,
wherein the first uplink forwarding link is established between the network node and the wireless communication node.

13. The wireless communication method of claim 12, wherein the second timing information, independent of timing information associated with a communication link, indicates that the timing of the first uplink forwarding link is equal to the timing of the second downlink forwarding link.

14. The wireless communication method of claim 13, further comprising:
determining, by the network node, based on third timing information associated with a second uplink forwarding link and at least one of the timing of the timing of the first uplink forwarding link, the timing of the second downlink forwarding link, or the timing of the first downlink forwarding link, a timing of the second uplink forwarding link,
wherein the second uplink forwarding link is established between the network node and the wireless communication device.

15. The wireless communication method of claim 14, wherein the third timing information, independent of timing information associated with a communication link, indicates a third time difference between the timing of the second uplink forwarding link and the timing of the first uplink forwarding link.

16. The wireless communication method of claim 1, further comprising:
sending, by the network node to a wireless communication node, one or more capability parameters each indicating at least one switching delay that the network node can support; or
sending, by the network node to a wireless communication node, a plurality of capability parameters, each of the plurality of capability parameters corresponding to a time delay of a switching scenario.

17. The wireless communication method of claim 1, further comprising:
receiving, by the network node from a wireless communication node, a number of guard symbols or a reserved time blank duration corresponding one of a plurality of switching scenarios.

18. A wireless communication method, comprising:
sending, by a wireless communication node to a network node, first timing information associated with a first downlink forwarding link,
wherein the first downlink forwarding link is established between the network node and a wireless communication device.

19. A wireless communication node, comprising:
at least one processor configured to:
send, via a transmitter to a network node, first timing information associated with a first downlink forwarding link,
wherein the first downlink forwarding link is established between the network node and a wireless communication device.

20. A network node, comprising:
at least one processor configured to:
determine based on first timing information associated with a first downlink forwarding link, a timing of a first downlink forwarding link,
wherein the first downlink forwarding link is established between the network node and a wireless communication device.
